(19) United States
(12) Patent Application Publication
(10) Pub. No.: US 2018/0074745 A1
(43) Pub. Date: Mar. 15, 2018

(54) Managing Volumes with Deduplication using Volume Sketches

(71) Applicant: International Business Machines Corporation, Armonk, NY (US)

(72) Inventors: Danny Harnik, Tel Mond (IL); Ronen Kat, Kokav-Yair (IL); Ety Khaitzin, Shaar ion (IL)

(21) Appl. No.: 15/262,066

(22) Filed: Sep. 12, 2016

(51) Int. Cl. G06F 3/06

(52) U.S. Cl. CPC G06F 3/0641; G06F 3/0683; G06F 3/0644; G06F 3/0608

(57) ABSTRACT

This invention relates to a system and method for managing deduplication of volume regions. A storage controller receives the volume hashes of the data stored on a set of storage devices and produces a set of volume sketches. The volume sketches represent a fraction of the hashes. From these sketches and mergers of sketches, the deduped storage size is estimated. The sketches also integrate compression ratios in systems combining both deduplication and compression and are combined with off-line scans in systems that do not have deduplication.

### FIELD OF TECHNOLOGY

The present invention relates to the technical field of storage systems. In particular, the present invention relates to managing storage deduplication.

### BACKGROUND OF THE INVENTION

As computer data storage and data bandwidth requirements increase, so too does the amount and complexity of data that businesses daily manage. Large-scale distributed storage systems, including computing and storage clusters, support multiple users across varying applications. Such clusters are typically configured as centralized repositories, either physical or virtual, for the storage, management, and dissemination of data pertaining to one or more users. A distributed storage system may be coupled to client computers interconnected by one or more networks.

These clusters employ software-based applications, including a logical volume manager or a disk array manager, to provide a means of allocating space to users. In addition, these software-based applications allow a system administrator to create units of storage groups including logical volumes. Storage virtualization provides an abstraction of logical storage from physical storage in order to access logical storage without end-users identifying physical storage.

To support storage virtualization, a volume manager performs input/output (I/O) redirection by translating incoming I/O requests using logical addresses from end-users into new requests using addresses associated with physical locations in the storage devices. As some storage devices may include additional address translation mechanisms, such as address translation layers which may be used in solid state storage devices, the translation from a logical address to another address mentioned above may not represent the only or final address translation.

For many storage systems, large regions of separate logical addresses often include the same data, or are reused among multiple volumes. Efforts to reduce the amount of identical data stored in the storage system are needed to improve the efficiency and operational capacity of the storage system. In particular, deduplication is a popular method for reducing bandwidth and storage capacities.

For many data storage environments, the savings associated with deduplication are large. Many workloads contain inherent repetitions. For example, a data storage system may include large numbers of virtual machines. The base installation of the virtual machine may be the same for multiple volumes, resulting in the duplication of large regions of data in multiple volumes. Other workloads include backup snapshots, cloud data sharing services, and storage for the cloud. Recently, there has been interest in the use of deduplication solutions in primary data storage. The main case is for all-flash storage and their use for several application virtual machine environments, data bases copies, mail servers, and others. All-flash storage supports high performance but has a higher cost per GB than traditional disk based storage. Therefore, a need exists for reducing the storage overhead with deduplication.

However, deduplication is typically done at a full machine level. Managing deduplication at a volume level is difficult for several reasons. For example, it is unclear how to answer the following questions in such cases: How much internal deduplication does a particular volume have? How much cross deduplication is there between two or more volumes, such in the case of the overlapping volumes shown in FIG. 1? Note that volumes in this context are logical abstractions of a part of the storage space. Embodiments of the present invention can work for any alternative abstraction such as a storage pool, a large file, a directory, an object or logical collection of objects.

Being able to answer these questions for volumes becomes useful for several reasons. First, these properties enable a determination of how much space will be saved by erasing a specific volume or a combination of volumes. Note that with deduplication the answer can be zero in the case that the entire volume is deduplicated. Second, these properties also help determine how much space deduplication will save when moving an existing volume to a different system that has deduplication and other data. This determination is crucial when having several storage systems which serve as “deduplication domains,” where dedupe only occurs within a domain. Finally, in many cases knowledge of the data reduction properties of a subset of the storage (e.g. a logical storage pool) can help for accounting purposes and billing of used storage capacity.

### SUMMARY OF INVENTION

The present invention, in an embodiment, relates to a light and efficient mechanism to be integrated in a storage system with deduplication. The mechanism enables quick estimation of the deduplication properties of logical storage volumes and collections of such volumes to help manage storage systems with deduplication.

The present invention, in an aspect, applies a core technique of holding a small and representing fraction of the hash values that were seen in each of the volumes in the system, (herein, “volume sketch”). From these volume sketches and mergers of volume sketches, one can extrapolating the estimated deduped storage size according to the sketch.

In another aspect, the volume sketches also integrate compression ratios (in systems combining both deduplication and compression) and can be combined also with off-line scans for systems that do not have deduplication.

The invention relates to tools for managing volumes in a multi-dedupe domain environment. Having such tools helps in managing deduplication on a single system, but more importantly, is crucial for benefiting from deduplication in large data center and cloud environments, where the sheer scale does not allow a single deduplication domains.

In embodiments, systems comprises a plurality of logical volumes, and a storage controller coupled to the plurality of logical volumes, where the storage controller comprises a software application comprising a deduplication process that generates a set of hash values corresponding to the data chunks on the plurality of logical volumes, and is configured to maintain a volume sketch table to track relationships between underlying data stored on the plurality of volumes and determine an estimated deduplication ratio for the plurality of volumes based on the corresponding volume sketches, where the volume sketch table comprises at least one special hash, and where the at least one special hash comprises a subset of the set of hash values.

In optional embodiments, a ratio between the range of all possible hashes and the range of all possible special hashes is determined according to a specified accuracy. In alternative embodiments, a ratio between the range of all possible hashes and the range of all possible special hashes increases as the number of total hashes in a specific logical volume increases. In preferred embodiments, the at least one special hash is determined by a specific pattern of bits. The storage controller may be optionally configured to estimate a combined compression and deduplication ratio by recording a compression ratio of the data chunks with hashes corresponding to the hashes in the at least one special hashes, calculating a space required to store the chunks corresponding to the at least one special hash, and producing a data reduction estimate in embodiments. Maintaining a volume sketch table may comprise scanning all hash metadata for each volume and storing only special hashes in optional embodiments. In preferred embodiments, the storage controller is further configured to compute a space saving from deleting at least one logical volume by calculating an estimate of space usage of all logical volumes and comparing the estimate of space usage of all logical volumes with a combined space of all other logical volumes.

Numerous other embodiments are described throughout herein. All of these embodiments are intended to be within the scope of the invention herein disclosed. Although various embodiments are described herein, it is to be understood that not necessarily all objects, advantages, features or concepts need to be achieved in accordance with any particular embodiment. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein.

The methods and systems disclosed herein may be implemented in any means for achieving various aspects, and may be executed in a form of a machine-readable medium embodying a set of instructions that, when executed by a machine, cause the machine to perform any of the operations disclosed herein. These and other features, aspects, and advantages of the present invention will become readily apparent to those skilled in the art and understood with reference to the following description, appended claims, and accompanying figures, the invention not being limited to any particular disclosed embodiment(s).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates overlapping volumes with duplication.

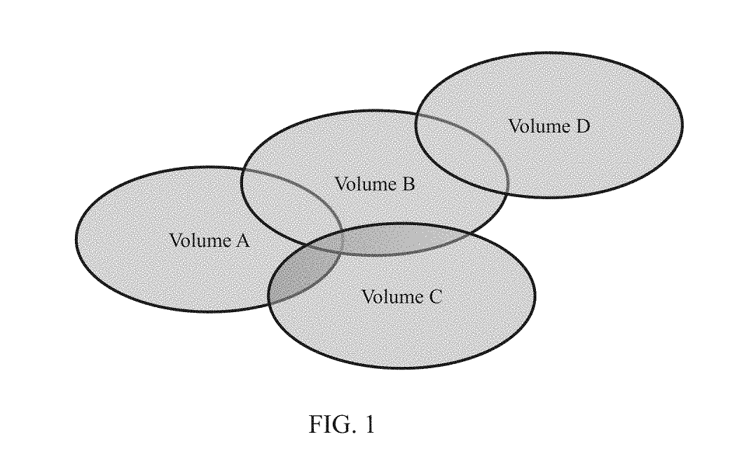

FIG. 2 illustrates a system diagram according to an embodiment of the present invention.

FIG. 3 illustrates an exemplary set of volumes and a volume sketch, according to an embodiment of the present invention.

FIG. 4 illustrates a program flow according to an embodiment of the present invention.

FIG. 5 illustrates a program flow according to an embodiment of the present invention.

FIG. 6 illustrates a program flow for estimating the deduplicated storage size, according to an embodiment of the present invention.

Other features of the present embodiments will be apparent from the Detailed Description that follows.

### DETAILED DESCRIPTION OF THE EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical and structural changes may be made to the embodiments without departing from the spirit and scope of the present teachings. The following detailed description is therefore not to be taken in a limiting sense, and the scope of the present disclosure is defined by the appended claims and their equivalents.

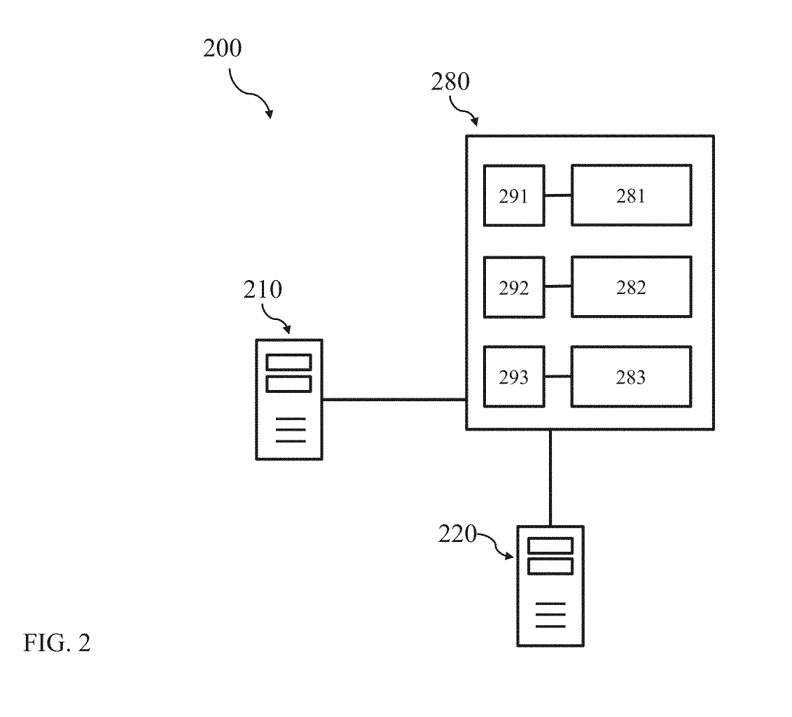

FIG. 2 illustrates a system 200 diagram according to an embodiment of the present invention. A first client 210 and a second client 220 connect to a distributed storage device 280. The distributed storage device 280 acts as a storage controller and manages the various volumes. The distributed storage device 280 is comprised of several processing units 291, 292, 293 coupled to several physical storage devices 281, 282, 283. Each processing unit 291, 292, 293 may connect to a single, several, or all of the storage devices 281, 282, 283. The distributed storage device 280 can implement a distributed application that manages deduplication and implements the processes described herein.

The logical volumes are a virtual abstraction of a block device. These volumes may be stored on physical storage elements. The volumes may be such that volumes and physical storage element correspond to each other. Alternatively, multiple volumes can be stored on a single physical storage element. The volumes may also extend across physical storage elements. The physical storage elements may correspond to disk drives, memory devices, and the like. The distributed storage device 280 implements an application for managing deduplication that uses volume sketches. Logical volumes are managed by the storage controller and eventually are stored across the storage devices 281, 282, 283.

The distributed storage device 280 is representative of any number of storage device groups (or data storage arrays). The physical storage devices may be any of a number and type of storage devices, including solid-state drives, hard disk drives, and ramdisks. The distributed storage device 280 may be coupled directly to a client 210, or may be coupled remotely over network to a client 220. Clients 210 and 220 are representative of any number of clients which may utilize distributed storage device 280 for storing and accessing data in system 200. It is noted that some systems may include only a single client, connected directly or remotely to distributed storage device 280.

Distributed storage device 280 may include software and/or hardware configured to provide access to logical volumes stored across the physical storage devices 281, 282, 283. In some embodiments, the distributed storage device 280 may be located within one or each of the physical storage devices. Distributed storage device 280 may include or be coupled to an operating system (OS), a volume manager, and additional control logic for implementing the various techniques disclosed herein.

Distributed storage device 280 may include and/or execute on any number of processors and may include and/or execute on a single host computing device or be spread across multiple host computing devices, depending on the embodiment. In some embodiments, Distributed storage device 280 may generally include or execute on one or more file servers and/or block servers. Distributed storage device 280 may use any of various techniques for managing data across volumes. Distributed storage device 280 may also utilize any of various deduplication techniques for reducing the amount of data stored in the logical volumes by deduplicating common data segments.

Without a loss of generality, we consider a deduplication system that breaks the data into chunks and computes hashes per each chunk. Specifics, such as chunk size, are irrelevant and the system works with most deduplication methods. The system estimates the deduplication potential of volumes, and additional properties such as missing out on dedupe due to specific deduplication implementations can be estimated on top of this.

In an embodiment, a system with deduplication produces all of the information required. However, there is little metadata held at the volume level to understand deduplication. Going over all of the volumes and their owned data chunks (hashes of chunks), and, when it exists, understanding the deduplication relations in a large scale system is far too taxing from a computation and I/O standpoint. The process must be streamlined to be feasible.

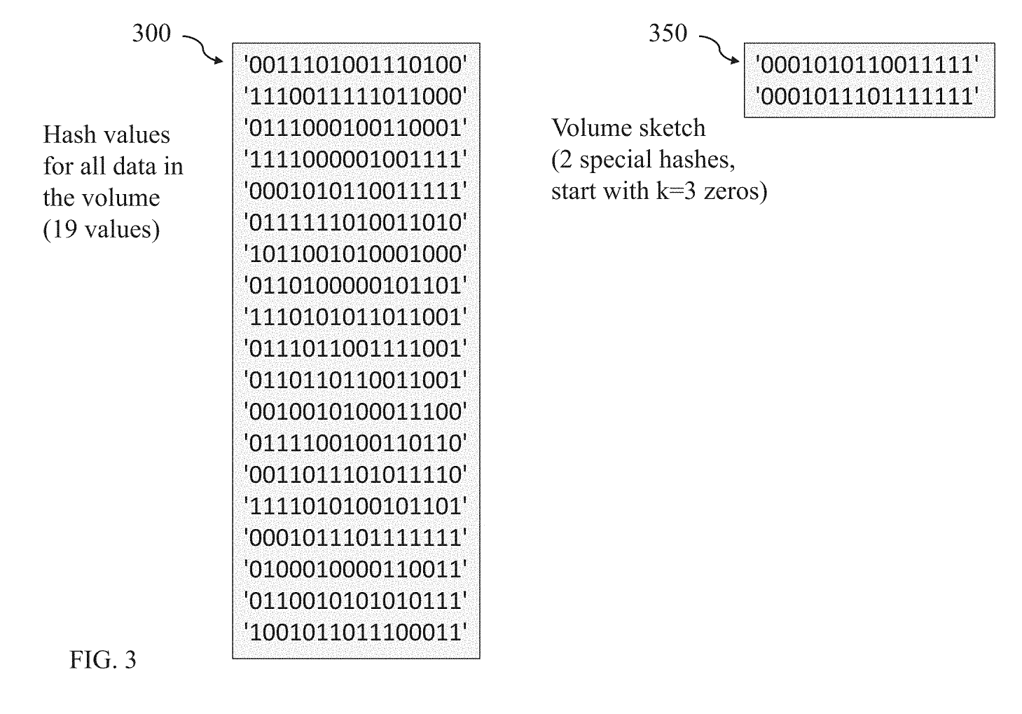

The core process used by the system consists of the following basic concept: a volume sketch consists of all the hashes that are in the volume and have a special property (herein, “special hashes”). An example is all the hashes that start with 16 zero bits. In such a case, a sketch would hold approximately 1/65,536 of the hashes in the volume. By this downsizing, the process is made computationally feasible. The choice of 16 leading zeros as a filter to determine special hashes is a specific example. In general, the special hashes can be determined by any predefined or specific pattern of bits at any location in the bit string. For example, strings ending with the bit pattern “10011010” would be an equally a viable option as an 8 bit string, meaning that the sketch holds approximately 1/256 of the hashes that a volume holds. An example of the hash values and relating volume sketch is shown in FIG. 3. The hash value table 300 contains the hashes for all data in the volume. The volume sketch table 350 contains the special hashes. The volume sketches can be stored in a table format, although other data structures are possible, such as arrays, lists, or trees. In the example given, there are two special hashes that have the property of having a specific pattern of bits of k=3 leading zeros.

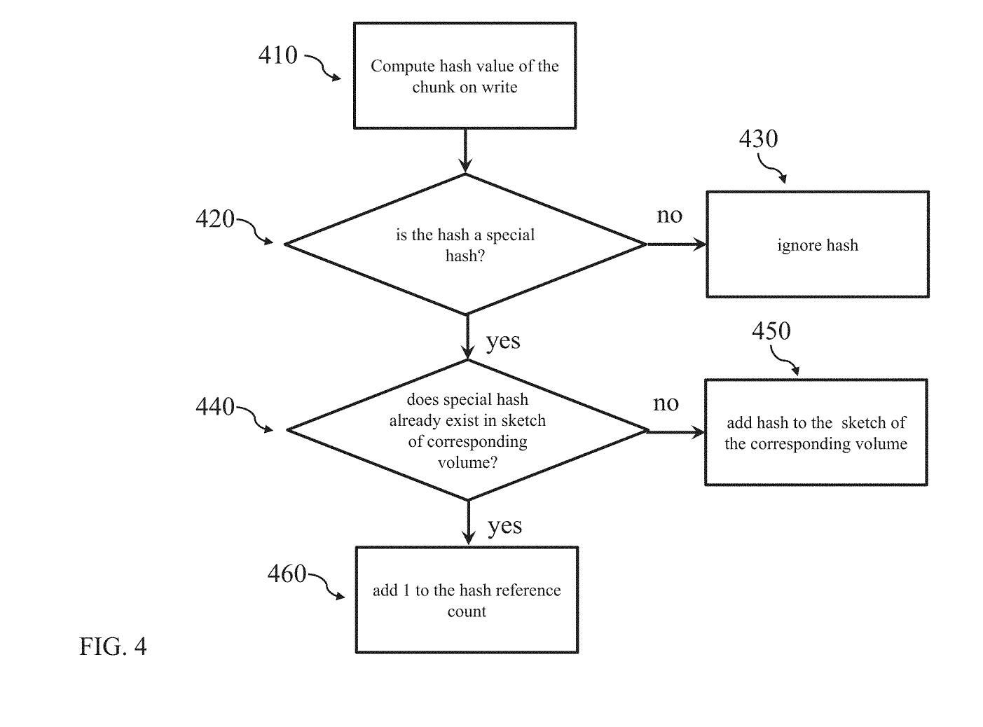

To maintain the sketches on every write, the system uses the process illustrated in FIG. 4. In step 410, the system computes a hash value. In step 420, the system determines whether or not the hash is a special hash. If the hash is not a special hash, the process ends in step 430. If the hash is a special hash, the system determines if the special hash already exists in the sketch of the corresponding volume in step 440. If the hash does not already exist in the sketch of the corresponding volume, the hash is added to the sketch of the corresponding volume in step 450. Otherwise, the system adds 1 to the hash reference count in step 560.

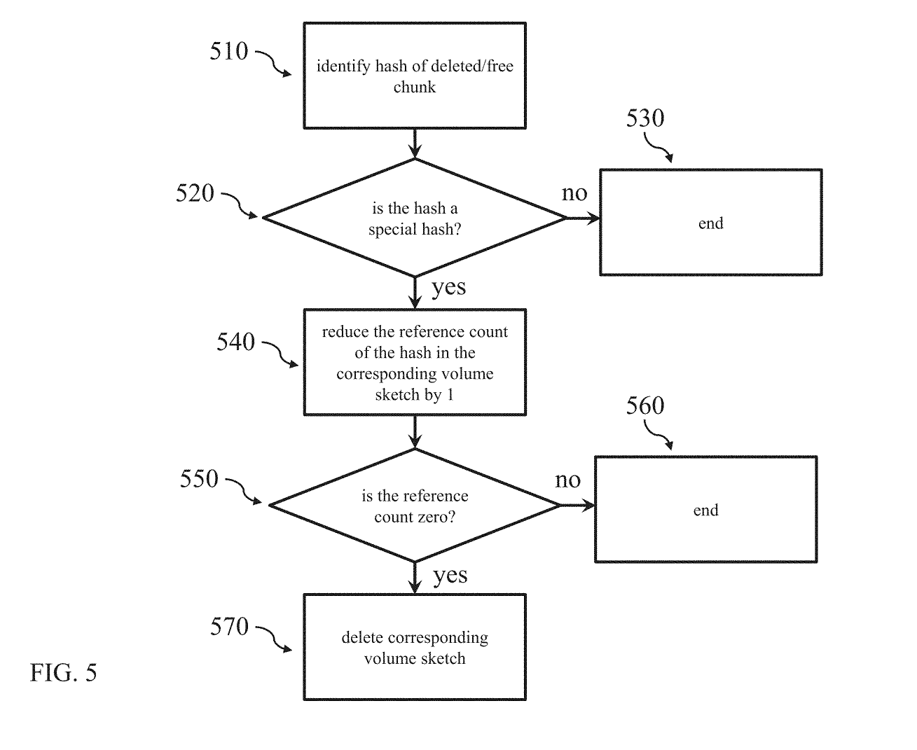

Similarly, for data overwrites and deletions the system uses the process illustrated in FIG. 5. In step 510, the system identifies the hash of the deleted/freed chunk. In step 520, the system determines if the hash is a special hash. If the hash is not a special hash, the process ends in step 530. If the hash is a special hash, the system reduces the reference count of the hash in the corresponding volume by 1 in step 540. In step 550, the system checks if the reference count is zero. If the reference count is zero, the system deletes the corresponding volume sketch and the process terminates in step 570. Otherwise, the process terminates in step 560.

Because operations are only done on special hashes, the overhead of adding this process in the main path is very low.

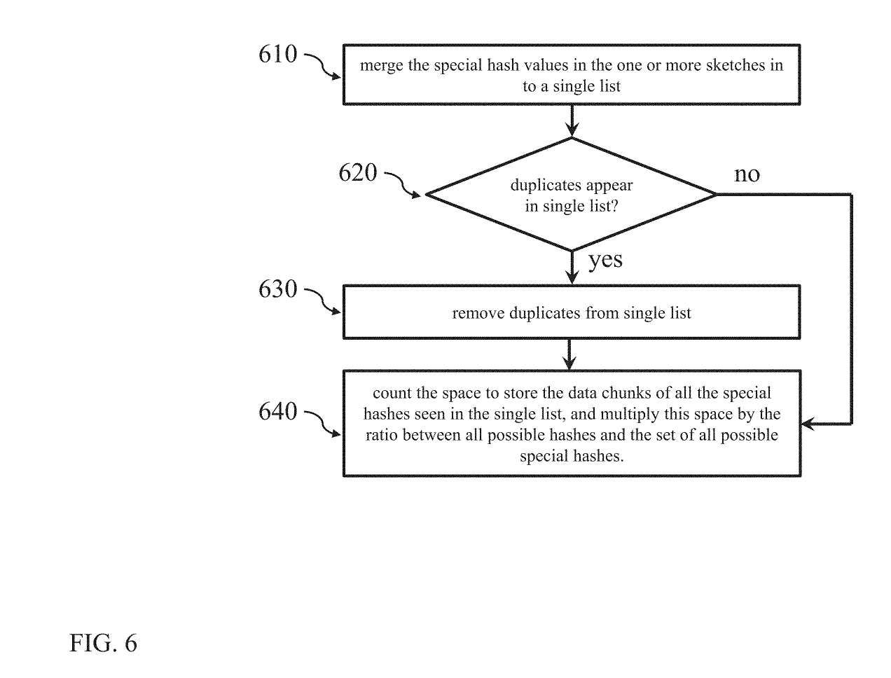

FIG. 6 illustrates a program flow for estimating the deduplicated storage size, according to an embodiment. At each point, the deduplicated storage size for one or more volumes can be estimated by the following process. In step 610, the system combines the sketches for all volumes simply by merging the special hash values in the one or more sketches in to a single list that contains all of the special hashes in the one or more sketches. In step 620, the system checks if there are duplicates that appear in the merged, single list. If the same hash value appears in more than one sketch then it is united into a single hash value in step 630. In step 640, the system counts the space it takes to store the data chunks of all the special hashes seen in the combined sketch, and multiplies this space by the ratio between all possible hashes and the set of all possible special hashes. In the example above (of 16 leading zeros), the multiplier would be 65,536. In the example of FIG. 3, the sketch holds two values (i.e., two hash values corresponding to special hashes) and the ratio is ½̂3=⅛. Thus the estimated physical size to store the entire volume hashes would be 2*8=16 data chunks.

The ratio between all possible hashes and all possible special hashes (in our example, the number of leading zeros that make a hash a special one) can be determined according to the desired accuracy. The smaller this ratio is, the more accurate the estimation will be. On the other hand, the overhead of managing the sketches (and the size of the sketches) increases. Statistical analysis can be used to determine the ratio.

Another option is that the ratio between the range of all possible hashes and the range of all possible special hashes can increase as the number of total hashes in the observed volume grows. Rather than looking at a fixed fraction (using a fixed parameter k) the system can keep a large fraction of the hashes for volumes that have few hashes and dilute these as the volumes content grows. In this way, the system can give a decent estimation for small volumes. For example, one possible embodiment may start with special hashes being those hashes that start with k leading zeros (for a small k, e.g., k=3). Once there are too many of these in the sketch, the criteria can be changed by increasing k (e.g. k=4 leading zeros). Then, the sketch is diluted by approximately half and does not grow arbitrarily.

An alternative embodiment can always maintain a fixed number of minimal hashes (where minimal is the smallest according to some ordering, for example, when ordered lexicographically). For example, only the m=10,000 smallest hashes may be kept. This method has a very similar effect as the previous embodiment.

Combining compression ratios can be done by recording the compression ratio of the chunks with special hashes and then calculating the space it takes to store the special chunks accordingly. For example, in FIG. 3 there are two hashes in the sketch. Suppose that one of these data chunks compresses by ½ and the other compresses by ¾. This means that the space to store the two chunks would be ½+¼=¾ of a data chunk. The estimated overall space to store the entire data set would thus be ¾*8=6 data chunks. From such a practice one can derive an estimated data reduction number. Data reduction refers to the combination of deduplication and then compression, and the data reduction estimate is the estimated space savings from the combination of these two.

An alternative embodiment maintains the sketches (rather than the above “bump-in-the-wire” process) by performing a scan of all hash metadata for each volume and storing only the special hashes. This process avoids the need to handle deletions and overwrites, but requires a scan of all metadata which can be lengthy and the resulting sketches can be stale by the time the scan ends.

In addition, computing the space saving of deleting a particular volume can be done by estimating the space usage of all volumes and comparing it with the combined space of all volumes except for the particular volume.

The preceding description relates to volumes on block storage. However, the same process can be applied to files, objects, containers, or other data storage formats.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing written description of the invention enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the within disclosures are exemplary only and that various modifications may be made within the scope of the present invention. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

What is claimed is:

1. A system comprising:
a plurality of logical volumes comprising a set of data chunks; and
a storage controller coupled to the plurality of logical volumes, wherein the storage controller:
comprises a software application comprising a deduplication process that generates a set of hash values corresponding to the set of data chunks of the plurality of logical volumes, and
is configured to maintain a volume sketch table to track relationships among the set of data chunks on the plurality of volumes and determine an estimated deduplication ratio for the plurality of volumes based on the volume sketch table, wherein the volume sketch table comprises at least one special hash, and wherein the at least one special hash comprises a subset of the set of hash values.

2. The system of claim 1, wherein a ratio between the range of all possible hashes and the range of all possible special hashes is determined according to a specified accuracy.

3. The system of claim 1, wherein a ratio between the range of all possible hashes and the range of all possible special hashes increases as the number of total hashes in a specific logical volume increases.

4. The system of claim 1, wherein the at least one special hash is determined by a specific pattern of bits.

5. The system of claim 1, wherein the storage controller is further configured to estimate a combined compression and deduplication ratio by recording a compression ratio of the data chunks with hashes corresponding to the hash values in the at least one special hash, calculating a space required to store the chunks corresponding to the at least one special hash and producing a data reduction estimate.

6. The system of claim 1, wherein maintaining a volume sketch table comprises scanning all hash metadata for each volume and storing only special hashes.

7. The system of claim 1, wherein the storage controller is further configured to compute a space saving from deleting at least one logical volume by calculating an estimate of space usage of all logical volumes and comparing the estimate of space usage of all logical volumes with a combined space of all other logical volumes.

8. A method for estimating deduplication sizes, the method comprising:
calculating a hash value from a chunk on at least one volume;
determining if the hash value is a special hash;
if the hash value is a special hash, determining if the special hash exists in a sketch of a volume corresponding to the hash value;
if the hash value is a special hash and the special hash does not exist in a sketch of a volume corresponding to the hash value, adding the hash value to the sketch of the volume;
and determining an estimated deduplication ratio based on the sketch of a volume.

9. The method of claim 8, wherein a ratio between all hashes and special hashes is determined according to a specified accuracy.

10. The method of claim 8, wherein a ratio between the range of all possible hashes and the range of all possible special hashes increases as the number of total hashes in the specific volume increases.

11. The method of claim 8, wherein the special hash is determined by a pattern of bits in the corresponding hash value.

12. The method of claim 8, further comprising the step of estimating a combined compression and deduplication ratio by recording a compression ratio of the chunks with special hashes, calculating a space required to store the chunks corresponding to special hashes, and producing a data reduction estimate from it.

13. The system of claim 8, wherein the storage controller is further configured to compute a space saving from deleting at least one volume by calculating an estimate of space usage of all volumes and comparing the estimate of space usage of all volumes with a combined space of all other volumes.

14. A system comprising:
a plurality of volumes, wherein the plurality of volumes comprises at least one data chunk; and
a storage controller coupled to the plurality of volumes, wherein the storage controller is configured to:
maintain a volume sketch table to track relationships among the at least one data chunk and determine an estimated deduplication ratio based on the volume sketch table, wherein the volume sketch table comprises at least one hash value of the at least one data chunk in the plurality of volumes, and wherein the at least one hash value corresponds to a hash value in a designated set of hashes.

15. The system of claim 14, wherein a ratio between all possible hashes and the designated set of hashes is determined according to a specified accuracy.

16. The system of claim 15, wherein the designated set of hashes becomes smaller as the number of total hashes in a specific volume increases.

17. The system of claim 14, wherein the designated set of hashes is determined by a pattern of bits in the corresponding hash.

18. The system of claim 14, wherein the storage controller is further configured to estimate a combined compression and deduplication ratio by recording a compression ratio of data chunks with hashes in the designated set of hashes, calculating the space required to store the data chunks with hashes in the designated set of hashes, and producing a data reduction estimate.

19. The system of claim 14, wherein maintaining a volume sketch table comprises scanning all hash metadata for each volume and storing only the hash values in the hash metadata corresponding to the designated set of hashes.

20. The system of claim 14, wherein the storage controller is further configured to compute a space saving from deleting a volume by calculating an estimate of space usage of all volumes and comparing the estimate of space usage of all volumes with a combined space of all other volumes.
